(19) United States
(12) Patent Application Publication
(10) Pub. No.: US 2022/0256564 A1
(43) Pub. Date: Aug. 11, 2022

(54) MAINTAINING INDUSTRIAL INTERNET OF THINGS (IIOT) SCHEDULING AVAILABILITY

(71) Applicant: Nokia Technologies Oy, Espoo (FI)

(72) Inventors: Guillermo Pocovi, Aalborg (DK); Zexian Li, Espoo (FI); Qiping Zhu, Wheaton, IL (US)

(21) Appl. No.: 17/172,901

(22) Filed: Feb. 10, 2021

(51) Int. Cl. H04W 72/12; H04W 72/14; H04L 1/18; H04L 5/00; H04W 80/02; H04W 76/27

(52) U.S. Cl. CPC H04W 72/1257; H04W 72/14; H04W 72/1289; H04W 76/27; H04L 5/0053; H04W 80/02; H04L 1/1819

(57) ABSTRACT

Various techniques are provided for configuring, by a network device for a user equipment (UE), a semi-persistent resource allocation configuration for a second cell, causing, by the network device, communication between the UE and the second cell using the semi-persistent resource allocation configuration based on an unavailability of a first cell, and causing, by the network device, the communication between the UE and the second cell using the semi-persistent resource allocation configuration to stop based on an availability of the first cell.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include configuring, by a network device for a user equipment (UE), a semi-persistent resource allocation configuration for a second cell, causing, by the network device, communication between the UE and the second cell using the semi-persistent resource allocation configuration based on an unavailability of a first cell, and causing, by the network device, the communication between the UE and the second cell using the semi-persistent resource allocation configuration to stop based on an availability of the first cell.

Implementations can include one or more of the following features, alone, or in any combination with each other. For example, the semi-persistent resource allocation configuration can include at least one of a semi-persistent scheduling (SPS) configuration and a configured grant (CG) configuration as a CG/SPS configuration. The method can further include configuring, by the network device for the UE, at least one of a SPS configuration and a CG configuration as a CG/SPS configuration for at least one additional cell, causing, by the network device, communication between the UE and the at least one additional cell using the CG/SPS configuration for the at least one additional cell based on the unavailability of the first cell and the second cell, and causing, by the network device, communication between the UE and the at least one additional cell using the CG/SPS configuration for the at least one additional cell to stop based on the availability of the first cell. The method can further include communicating, by the network device to the UE, a CG/SPS configuration for the second cell with a downlink control information (DCI) and receiving, by the network device from the UE, a hybrid automatic repeat request (HARQ)-acknowledgement (ACK) feedback with the DCI.

The method can further include communicating, by the network device to the UE, a CG/SPS configuration for the second cell with a downlink control information (DCI) and receiving, by the network device from the UE, a Configured Grant Confirmation medium access control (MAC) control element (CE) with the DCI. After the first cell is available for scheduling, delaying the stopping of the communication between the UE and the second cell based on one of a fixed period of time, after a timer has expired, a number of symbols, a number of slots, or a completion of a HARQ retransmission. A CG/SPS configuration for the second cell can be linked to at least one of the first cell and additional cells based on a cell identification included in a radio resource control (RRC) configuration of the SPS/CG configuration and the CG/SPS configuration for the second cell can be used if resources from a CG/SPS configuration for at least one of the first cell and the additional cells are not available due to a scheduling unavailability. The method can further include communicating, by the network device to the UE, at least one of a SPS configuration and a CG configuration as a CG/SPS configuration for the first cell wherein a CG/SPS configuration for the second cell is linked to the CG/SPS configuration for the first cell and the CG/SPS configuration for the second cell is used if at least one resource from the CG/SPS of the first configuration is not available due to a scheduling unavailability.

The method can further include exchanging, between the first cell and the second cell, information on scheduling restrictions/unavailability based on cell-wide restrictions/unavailability, UE-specific scheduling restrictions/unavailability, or a combination of cell-wide restrictions/unavailability and UE-specific scheduling restrictions/unavailability. The network device is a first network device and the second cell is associated with a second network device, the method can further include communicating, by the first network device to the second network device, a portion of the CG/SPS configuration for the second cell using signalling over at least one of a F1 interface and a Xn interface. The method can further include determining the first cell is unavailable based on at least one of a TDD configuration, UE intra-cell/inter-cell measurements, beam alignment, mobility measurements on neighbouring cells, and handover interruption time.

According to another example embodiment, a method may include communicating, by a user equipment (UE), on a first cell, receiving, by the UE from a network device, a semi-persistent resource allocation configuration for a second cell, causing, by the UE, communication between the UE and the second cell using the semi-persistent resource allocation configuration based on an unavailability of the first cell, and causing, by the UE, the communication between the UE and the second cell to stop based on an availability of the first cell.

Implementations can include one or more of the following features, alone, or in any combination with each other. For example, the semi-persistent resource allocation configuration can include at least one of a semi-persistent scheduling (SPS) configuration and a configured grant (CG) configuration as a CG/SPS configuration. The method can further include receiving, by the UE from the network device, at least one of a SPS configuration and a CG configuration as a CG/SPS configuration for at least one additional cell, causing, by the UE, communication between the UE and the at least one additional cell using the CG/SPS configuration for the at least one additional cell, and causing, by the UE, communication between the UE and the at least one additional cell using the CG/SPS configuration for the at least one additional cell to stop. After the first cell is available for scheduling, delaying the stopping of the communication between the UE and the second cell based on one of a fixed period of time, after a timer has expired, a number of symbols, a number of slots, or a completion of a HARQ retransmission. A CG/SPS configuration for the second cell can be linked to at least one of the first cell and additional cells based on a cell identification included in a radio resource control (RRC) configuration of the SPS/CG configuration and the CG/SPS configuration for the second cell can be used if resources from a CG/SPS configuration for at least one of the first cell and the additional cells are not available due to a scheduling unavailability.

The method can further include receiving, by the UE from the network device, at least one of a SPS configuration and a CG configuration as a CG/SPS configuration for the first cell wherein a CG/SPS configuration for the second cell is linked to the CG/SPS configuration for the first cell and the CG/SPS configuration for the second cell is used if at least one resource from the CG/SPS of the first configuration is not available due to a scheduling unavailability. The method can further include determining the first cell is unavailable based on at least one of a TDD configuration, UE intra-cell/inter-cell measurements, beam alignment, mobility measurements on neighbouring cells, and handover interruption time.

An example implementation can include a non-transitory computer-readable storage medium including instructions that can be executed by at least one processor to cause a computing system to perform any one of the methods described above. An example implementation can include means for performing any one of the methods described above. Example implementations can include an apparatus including at least one processor and at least one memory. The memory can include computer program code that can be executed by at least one processor to cause a computing system to perform any one of the methods described above.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to at least one example embodiment.

FIG. 2 is a block diagram of a wireless network according to at least one example embodiment.

FIG. 3 is a block diagram illustrating a scheduling technique according to at least one example embodiment.

FIG. 4 is a block diagram of a signal flow according to at least one example embodiment.

FIG. 5 is a block diagram of a method for wireless communication from the perspective of a primary cell according to at least one example embodiment.

FIG. 6 is a block diagram of a method for wireless communication from the perspective of a secondary cell according to at least one example embodiment.

FIG. 7 is a block diagram of a method for wireless communication from the perspective of a user equipment (UE) according to at least one example embodiment.

FIG. 8 is a flowchart illustrating operation of a network device according to at least one example embodiment.

FIG. 9 is a flowchart illustrating operation of a user equipment according to at least one example embodiment.

FIG. 10 is a block diagram of a wireless station or wireless node (e.g., AP, BS, gNB, RAN node, relay node, UE or user device, network node, network entity, DU, CU-CP, CU-CP, . . . or other node) according to an example embodiment.

### DETAILED DESCRIPTION

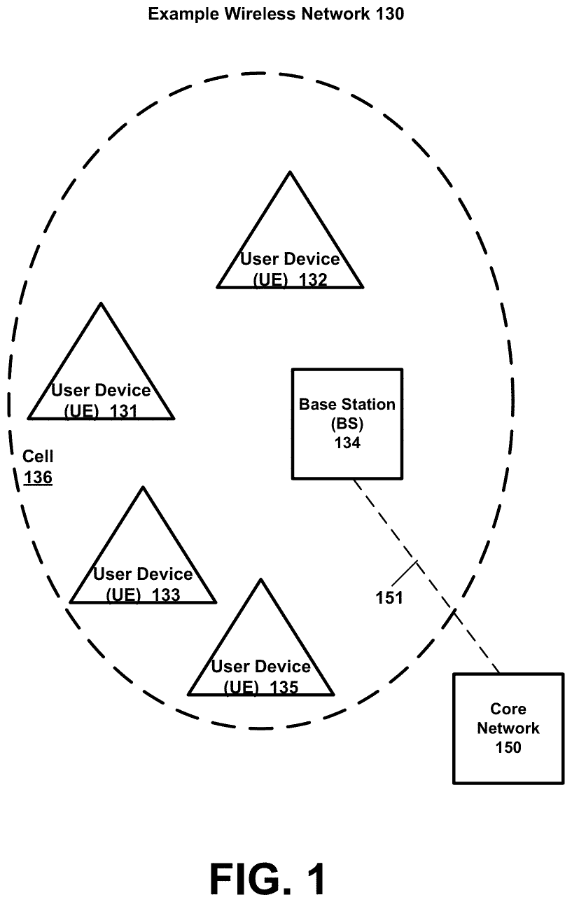

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a BS, next generation Node B (gNB), a next generation enhanced Node B (ng-eNB), or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS). At least part of the functionalities of a BS (e.g., access point (AP), base station (BS) or (e)Node B (eNB), BS, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface or NG interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node. For example, a BS (or gNB) may include: a distributed unit (DU) network entity, such as a gNB-distributed unit (gNB-DU), and a centralized unit (CU) that may control multiple DUs. In some cases, for example, the centralized unit (CU) may be split or divided into: a control plane entity, such as a gNB-centralized (or central) unit-control plane (gNB-CU-CP), and an user plane entity, such as a gNB-centralized (or central) unit-user plane (gNB-CU-UP). For example, the CU sub-entities (gNB-CU-CP, gNB-CU-UP) may be provided as different logical entities or different software entities (e.g., as separate or distinct software entities, which communicate), which may be running or provided on the same hardware or server, in the cloud, etc., or may be provided on different hardware, systems or servers, e.g., physically separated or running on different systems, hardware or servers.

As noted, in a split configuration of a gNB/BS, the gNB functionality may be split into a DU and a CU. A distributed unit (DU) may provide or establish wireless communications with one or more UEs. Thus, a DU may provide one or more cells, and may allow UEs to communicate with and/or establish a connection to the DU in order to receive wireless services, such as allowing the UE to send or receive data. A centralized (or central) unit (CU) may provide control functions and/or data-plane functions for one or more connected DUs, e.g., including control functions such as gNB control of transfer of user data, mobility control, radio access network sharing, positioning, session management etc., except those functions allocated exclusively to the DU. CU may control the operation of DUs (e.g., a CU communicates with one or more DUs) over a front-haul (Fs) interface.

According to an illustrative example, in general, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node (e.g., BS, eNB, gNB, CU/DU, . . . ) may forward data to the UE that is received from a network or the core network, and/or forward data received from the UE to the network or core network. RAN nodes (e.g., BS, eNB, gNB, CU/DU, . . . ) may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform. A base station may also be a DU (Distributed Unit) part of an IAB (Integrated Access and Backhaul) node (a.k.a. a relay node). DU facilitates the access link connection(s) for an IAB node.

A user device (user terminal, user equipment (UE), mobile terminal, handheld wireless device, etc.) may refer to a portable computing device that includes wireless mobile communication devices operating either with or without a subscriber identification module (SIM) (which may be referred to as Universal SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. A user device may be also a MT (Mobile Termination) part of an IAB (Integrated Access and Backhaul) node (a.k.a. a relay node). MT facilitates the backhaul connection for an IAB node.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network (e.g., which may be referred to as 5GC in 5G/NR).

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), massive MTC (mMTC), Internet of Things (IoT), and/or narrowband IoT user devices, enhanced mobile broadband (eMBB), and ultra-reliable and low-latency communications (URLLC). Many of these new 5G (NR)—related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE). A URLLC UE can have other type of services as well for example eMBB applications.

The various example embodiments may be applied to a wide variety of wireless technologies or wireless networks, such as LTE, LTE-A, 5G (New Radio (NR)), cmWave, and/or mmWave band networks, IoT, MTC, eMTC, mMTC, eMBB, URLLC, etc., or any other wireless network or wireless technology. These example networks, technologies or data service types are provided only as illustrative examples.

Industrial Internet of Things (IIoT) and Ultra-reliable low-latency communications (URLLC) applications can require data transmission with low-latency and high-reliability. 5G New Radio (NR) has standardized a set of URLLC/IIoT enablers in Rel-15, Rel-16 and ongoing Rel-17 standardization in 3GPP. Up to now, the standardization focusses on use cases requiring low data rates and/or small-payload transmission. For example, standardization focusses on use cases including 20 Bytes to 200 Bytes, with latency down to 0.5 ms and reliability up to 6-nines (99.9999%).

Semi-persistent scheduling techniques, such as Configured Grants (CG) in uplink (UL) and semi-persistent scheduling (SPS) in downlink (DL) can be regarded as key enablers for meeting the URLLC/IIoT requirements. SPS can be tailored to applications with periodic traffic where pre-configured DL resources can be provided periodically to the UE with, for example, periodicity and time offset aligned to the traffic arrivals. This SPS configuration can achieve lower control overhead as compared to dynamic scheduling and increased overall reliability by avoiding detection errors related to scheduling downlink control information (DCI).

URLLC/IIOT applications (e.g., related to audio and video professional applications (VIAPA use cases)) can require larger data rates and require similar levels of latency and reliability. For these use cases, spectrum below 6 GHz (e.g., Frequency Range 1 (FR1)) may not be sufficient. Spectrum at higher frequencies (e.g., FR2) having larger availability should be considered for these applications. These applications may need a low modulation and coding scheme (MCS) to ensure the reliability. Therefore, for some data rates, the occupied physical resource blocks (PRBs)/bandwidth may be large as compared to traditional mobile broadband applications.

Using the spectrum with more availability (e.g., FR2) can pose some challenges. The challenges can be related to the propagation conditions. For example, advanced beamforming with narrow/directional beams can be used to compensate for the larger pathloss. Another challenge can be related to hardware limitations (e.g., analog beamforming) resulting in some scheduling restrictions for the BS (e.g., gNB) and the UE.

There can be some UE scheduling restrictions/unavailability when operating at, for example, FR2 spectrum (e.g., as specified in TS 38.133) which may result in a URLLC UE not meeting its target latency/reliability requirement. One problem can be related to intra-frequency and inter-frequency measurements for mobility. To guarantee that the UE is served by the best serving cell/beam the UE needs to perform measurements on synchronization signal blocks (SSB) and/or channel state information reference signals (CSI-RS) transmitted from the serving and the neighbouring cells.

A scheduling restriction can include (e.g., section 9.1.2 in TS 38.133) when the UE requires measurement gaps to identify and measure inter-frequency neighbouring cells, a measurement gap pattern and a SSB measurement timing configuration (SMTC) is configured where the UE is not expected to transmit/receive from the serving cell. The shortest configurable measurement gap length may be 1.5 ms. Another scheduling restriction can include (e.g., section 9.2.5.3.3 in TS 38.133) for intra-frequency measurements of neighbour cell(s) without measurement gaps, the UE is not expected to transmit PUCCH/PUSCH/SRS or receive PDCCH/PDSCH/TRS/CSI-RS on SSB symbols to be measured, and on 1 data symbol before each consecutive SSB symbols to be measured and 1 data symbol after each consecutive SSB symbols to be measured within SMTC window. Another scheduling restriction can include (e.g., section 9.5.6.3 in TS 38.133) downlink beam refinement, when CSI-RS reference signals are repeated on a same beam while the UE sweeps the receive beam to determine the best receive beam. Some restrictions can be avoided when operating at, for example, FR1. For example, restrictions related to intra-frequency measurements can be avoided.

Example implementations can enable joint FR1-FR2 operation to guarantee high reliability and bandwidth availability simultaneously in industrial internet of things (IIoT) and/or ultra-reliable low-latency communications (URLLC) applications. Example implementations can include a UE being jointly served with FR1 and FR2 cells or carriers (e.g., using either carrier aggregation (CA) or Dual Connectivity (DC)). FR1 and FR2 can use separate transceivers. Therefore, the BS (gNB) can communicate to a UE via a FR1 carrier/cell even if there is a current scheduling restriction in the FR2 carrier/cell (and vice versa).

For example, for the carrier aggregation case, a DCI can be transmitted on the (more-reliable) FR1 cell, while the PDSCH (data) is transmitted on the (large-bandwidth) FR2 cell. However, for semi-static CG/SPS allocations, there are no resource and power efficient mechanisms exploiting this coordination. As an example, assume the BS (gNB) configures a UE with one or multiple SPS/CG resources in a FR2 carrier, in case of a scheduling restriction or unavailability in the FR2 carrier, the BS (gNB) may need to rely on dynamic signalling on the FR1 cell to, for example, provide dynamic DL assignment or UL grants to the UE, or temporarily activate a backup CG/SPS configuration in the FR1 carrier. This approach can consume a high amount of signalling and can be prone to errors which may jeopardize latency and reliability.

However, in an inter-band CA or DC scenario, example implementations disclosed herein target 100% scheduling availability by providing the UE with a backup SPS/CG occasion on one (e.g., FR1) cell which is conditionally used for reception/transmission when there is a scheduling unavailability/restriction on another (e.g., FR2) cell. Although FR1 and FR2 are used in some example implementations, the techniques described herein could be applied to any other DC/CA configuration (including FR2-FR2 or FR1-FR1). Scheduling unavailability/restriction(s) can include intra- and inter-frequency and intra- and inter-cell L1-RSRP measurements on SSB bursts, but could be also related to any other scheduling restrictions mobility-related measurements on neighbouring cells, handover interruption time, TDD frame configuration, and/or the like.

Example implementations can minimize radio resource usage/overhead and waste of gNB/UE decoding efforts. Further, example implementations may not require dynamic signalling which is prone to errors and increase control overhead.

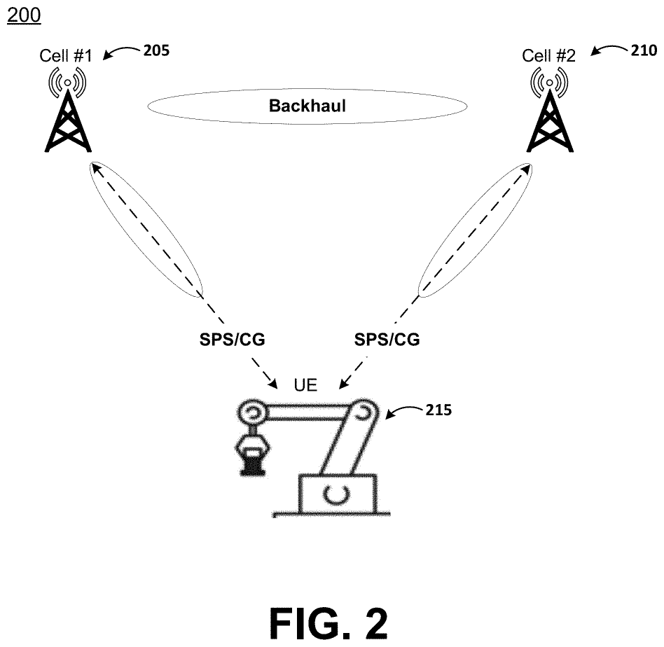

FIG. 2 is a block diagram of a wireless network according to at least one example embodiment. As shown in FIG. 2 wireless network 200 can include a cell #1 205, a cell #2 210, and a UE 215. Cell #1 205 can be a FR2 cell. Cell #2 210 can be a FR1 cell. However, cell #1 205 and cell #2 210 can be both be FR1, both be FR2 and/or any combination thereof. Cell #2 210 can be a backup or secondary cell for cell #1 205 (as a primary cell) for conducting communications with the UE 215. Therefore, cell #1 205 and cell #2 210 can be communicatively coupled with UE 215. In other words, cell #1 205 and cell #2 210 can be configured to wirelessly communicate with UE 215. Cell #1 205 and cell #2 210 can be a network device, a network entity, a BS, a gNB, an eNB, a relay station and/or the like. The considered scenario can be extended to cover sidelink where the involved nodes can be network node(s) or UE type of devices. The UE 215 can be an IIoT device.

The UE 215 and cell #1 205 can communicate using configured (e.g., by cell #1 205) resources. For example, the UE 215 and cell #1 205 can communicate via the configured SPS/CG resources or via dynamic signalling (e.g., where each PDSCH or PUSCH allocation is dynamically indicated with a DCI) associated with cell #1 205 and UE 215. Should cell #1 205 be unavailable for scheduling communications, the UE 215 and cell #2 210 can communicate via the configured SPS/CG resources associated with cell #2 210 and UE 215. When cell #1 205 is once again available for scheduling communications, UE 215 and cell #1 205 can communicate via the configured SPS/CG resources associated with cell #1 205 and UE 215. In an example implementation, the SPS/CG resources associated with cell #1 205 and UE 215 can be configured and then, while the SPS/CG resources associated with cell #1 205 and UE 215 are active, the SPS/CG resources associated with cell #2 210 and UE 215 can be configured as a backup resource. FIG. 2 is illustrated as including two BS (e.g., two towers). However, cell #1 205 and cell #2 210 can be associated with one or more BS (e.g., one or more towers). In other words, cell #1 205 at FR2 and cell #2 210 at FR1 can be associated with one BS (e.g., one tower). In case they are associated to more than one BS, cell #1 205 and cell #2 210 can communicate with each other via a backhaul connection, e.g., Xn interface, as well as via other proprietary or standardized backhaul/fronthaul interfaces. Cell #1 205 and cell #2 210 may also be associated to a common centralized unit (CU).

In some example implementations, the UE 215 and cell #1 205 can communicate using dynamic signalling (where each PDSCH or PUSCH allocation is dynamically indicated with a DCI). Should cell #1 205 be unavailable for scheduling communications, the UE 215 and cell #2 210 can communicate via the configured SPS/CG resources associated with cell #2 210 and UE 215. When cell #1 205 is once again available for scheduling communications, UE 215 and cell #1 205 can communicate again using dynamic signalling.

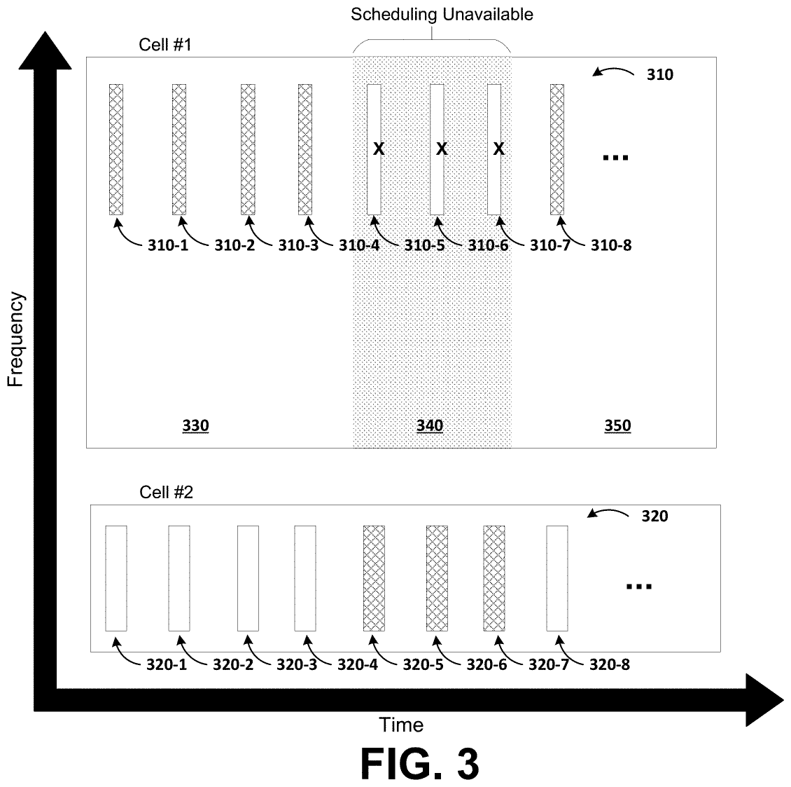

FIG. 3 is a block diagram illustrating a scheduling technique according to at least one example embodiment. As shown in FIG. 3, a cell #1 includes a plurality of scheduling blocks 310 for communications with a UE and a cell #2 includes a plurality of scheduling blocks 320 for communications with a UE. During a first time period 330, communications between cell #1 occurs using scheduling blocks 310-1, 310-2, 310-3, and 310-4. A second time period 340 is indicated as scheduling unavailable for cell #1. Therefore, scheduling blocks 310-5, 310-6, and 310-7 are not available for communications between cell #1 and the UE. During a third time period 350, scheduling is available in cell #1 and scheduling block 310-8 can be used for communications between cell #1 and the UE.

During the first time period 330 cell #2 has scheduling blocks 320-1, 320-2, 320-3, and 320-4 available and not used for communications between cell #2 and the UE. During the second time period 340 cell #1 is unavailable for scheduling. Therefore, scheduling blocks 320-5, 320-6, and 320-7 are used for communications between cell #2 and the UE. In other words, cell #2 can be a secondary or backup for cell #1 for communications with the UE when cell #1 is unavailable for scheduling for the UE. During the third time period 350, scheduling is available in cell #1, therefore scheduling block 320-8 is not used for communications between cell #2 and the UE.

In a more detailed example, cell #1 can be a FR2 cell and cell #2 can be a FR1 cell. Upon a scheduling unavailability on the FR2 cell, the UE starts receiving or transmitting data (PDSCH/PUSCH) on a backup SPS/CG occasion on the FR1 cell, without the need of explicit triggers or signalling (since the cells and UE knows the time instances where the UE cannot be scheduled due to scheduling restriction). SPS/CG allocations in cell #1 and cell #2 may be configured independently (e.g., different time-domain, frequency-domain allocation and/or MCS) as further described below.

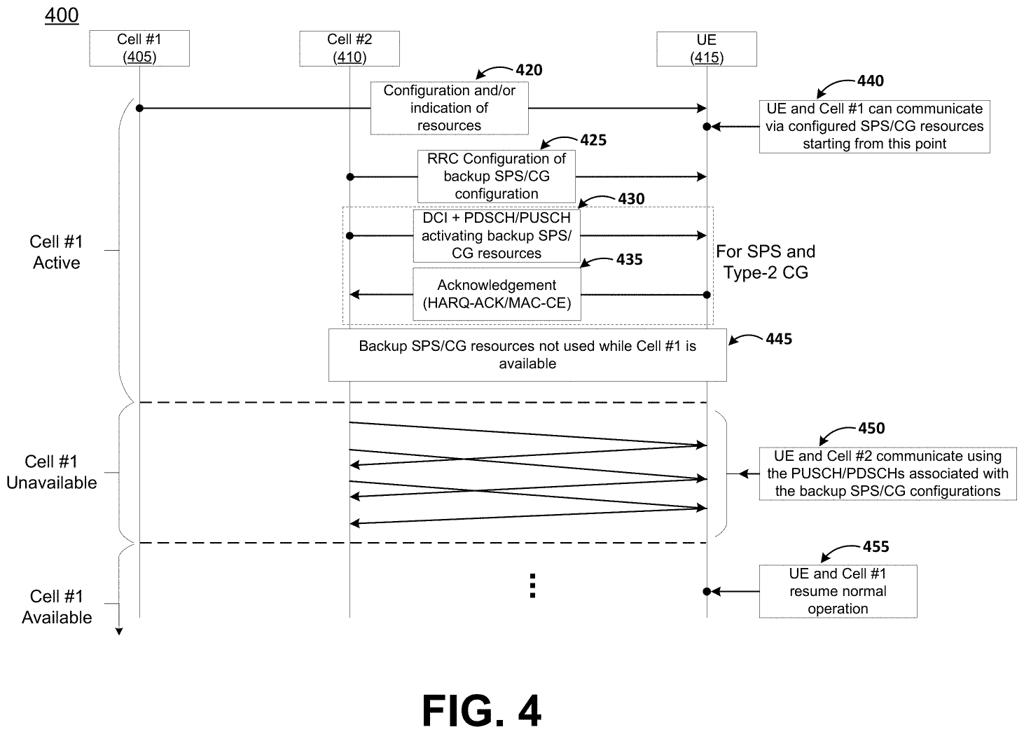

FIG. 4 is a block diagram of a signal flow according to at least one example embodiment. As shown in FIG. 4, signal flow 400 includes a cell #1 405, a cell #2 410 and a UE 415. Cell #1 405 can be a FR2 cell. Cell #2 410 can be a FR1 cell. However, cell #1 405 and cell #2 410 can be both be FR1, both be FR2 and/or any combination thereof. Cell #2 410 can be a second, secondary or backup cell for cell #1 405 for conducting communications with the UE 415. Therefore, cell #1 405 and cell #2 410 can be communicatively coupled with UE 415. In other words, cell #1 405 and cell #2 410 can be configured to wirelessly communicate with UE 415. Cell #1 405 and cell #2 410 can be a BS, a gNB, an eNB, and/or the like. The UE 415 can be an IIoT device or any type of user equipment. Cell #1 405 and cell #2 410 can be associated with one or more BS (e.g., one or more towers). In other words, cell #1 405 at FR2 and cell #2 410 at FR1 can be associated with one BS (e.g., one tower).

Cell #1 405 can communicate a message 420 (e.g., a configuration message or signal) to the UE 415. The message 420 can include information (e.g., instructions) for configuration and/or indication of resources for communications between cell #1 405 and the UE 415. The resources can include SPS/CG resources or dynamic signalling (e.g., where each PDSCH or PUSCH allocation is dynamically indicated with a DCI). After the activation of the SPS/CG resources, the UE 415 and cell #1 405 can communicate via the configured SPS/CG resources (440). Cell #1 405, e.g., as a gNB, can communicate with the UE 415 and provide the UE 415 with one or more SPS and/or CG configurations on one of the carriers/cells (e.g., as a primary CG/SPS configuration). For example, the primary CG/SPS configurations can be configured in cell #1 405 (e.g., the FR2 carrier/cell given FR2's large availability of spectrum). This can be accomplished by using a first RRC configuration step, followed by layer-1 activation via DCI for the case of DL SPS and Type-2 CG; whereas for Type-1 CG, RRC configuration is sufficient. PDSCHs/PUSCHs transmissions belonging to these primary SPS/CG configurations are illustrated in FIG. 3.

The BS can provide one or more additional SPS and/or CG configurations on another cell. One, multiple, or all of these SPS/CG configurations can be referred to as backup or conditional configurations meaning that the additional cell usage can be conditioned on a scheduling unavailability/restriction of another cell.

While cell #1 405 is active, the cell #2 410 can communicate messages (e.g., a configuration message or signal) to the UE 415. The messages can include an RRC configuration of a backup SPS/CG configuration (425). Further, for SPS and Type-2 CG, the messages can include DCI and PDSCH/PUSCH activating the backup SPS/CG resources (430) communicated from cell #2 410 to the UE 415 and an acknowledgement (e.g., HARQ-ACK/MAC-CE) communicated from the UE 415 to cell #2 410 (435). The backup SPS/CG resources may not be used (for communications with the UE 415) while cell #1 is available (445).

In an example implementation, individual backup SPS/CG configuration(s) can be linked to specific cell(s), e.g., via providing the cell ID as part of the RRC configuration of the SPS/CG. UE 415 can start receiving/transmitting on the backup SPS/CG configurations if there is a scheduling unavailability on those specific cell(s). For example, in case of CA/DC with one (1) cell #2 410 (e.g., FR1 carrier) and two (2) cell #1 405 (e.g., FR2 carriers), there can be one backup SPS/CG configuration that is used upon scheduling unavailability of the first cell #1 405 (e.g., FR2 cell), and another backup SPS/CG that is used upon scheduling unavailability of the second cell #1 405 (e.g., FR2 cell). As another example, there can be multiple SPS/CG configurations that are used upon scheduling unavailability for the first cell #1 405, the RRC configurations can be used to indicate the priority order of the multiple backup SPS/CG configurations.

In an example implementation, there can be an explicit link between the primary CG/SPS configurations associated with cell #1 405 and the backup CG/SPS configurations associated with cell #2 410 (e.g., the secondary carrier/cell). This technique could be done by defining a new global index number (e.g., configuredGrantConfigIndexGlobal) for a CG case, and referring to the global index of the primary SPS/CG configuration associated with cell #1 405 in the configuration of the backup SPS/CG associated with cell #2 410. Alternatively (or in addition), the linking can be done by providing both the cell ID and the cell-specific CG/SPS configuration ID (e.g., using an existing configuredGrantConfiglndex parameter).

When such link/relation is configured, the UE can start transmitting or receiving PUSCH/PDSCH belonging to the backup CG/SPS configuration (associated with cell #2 410) respectively if there is at least one CG/SPS of the linked configuration that is not received due to the scheduling unavailability/restriction. For the specific case of configured grants, the backup CG configuration (associated with cell #2 410) may in addition inherit logical channel restrictions of the linked configuration. For example, if traffic from logical channel 1 is mapped to the primary CG (associated with cell #1 405), then the corresponding backup CG (associated with cell #2 410) can also be used for such traffic.

In another example implementation, in a dual connectivity scenario, inter-gNB/cell signalling on F1 and/or Xn interfaces (e.g., the backhaul shown in FIG. 2) may be used. For example, cell #1 405 (e.g., the FR2 cell) may signal to cell #2 410 (e.g., the FR1 cell/carrier) the set of SPS/CG configurations that are configured or active for one or multiple UEs 415 (including potential SPS/CG configuration IDs as mentioned for some of the embodiments). Cell #1 405 may communicate a portion of the CG/SPS configuration to cell #2 410 using signalling over at least one of a F1 interface, —a Xn interface, and other type of backhaul or fronthaul interface. For example, cell #1 405 may not signal all the radio parameters to cell #2 410. Cell #1 405 may only signal periodicity, time offset, and/or the like to cell #2 410. The cell #2 410 (e.g., the FR1 cell/carrier) may use this information to set corresponding backup SPS/CG configurations. Alternatively (or in addition), cell #1 405 (e.g., the FR2 cell) may directly instruct or suggest the cell #2 410 (e.g., the FR1 cell/carrier) the way to configure a particular set of backup SPS/CG configurations. In other words, cell #1 405 could signal to the cell #2 410 (e.g., the periodicities and relative offsets of the resource, expected packet size or transport block size, and/or the like).

The BS (e.g., associated with cell #2 410) can transmit a DCI to activate/update the backup or conditional SPS/CG configurations (e.g., provide MCS, TD- and FD resource, Tx power, and/or the like). For SPS, the UE 415 can decode the SPS PDSCH scheduled with the DCI and provide HARQ-ACK feedback. For Type-2 CG, existing Configured Grant Confirmation MAC CE could be transmitted to the gNB. Remaining PDSCHs/PUSCHs of the backup or conditional configurations (e.g., those without associated DCI) are otherwise not monitored nor acknowledged as long as cell #1 405 (e.g., FR2 cell/carrier) is available. The UE 415 can acknowledge the activation of the SPS/CG configuration, however, an activation DCI may not be needed for Type-1 CG, where the CG resources are immediately active/available for the UE 415 after RRC configuration.

In case there is scheduling unavailability/restriction on cell #1 405 (e.g., FR2 call) (see FIG. 3), the UE 415 can for SPS, start receiving PDSCH belonging to the backup SPS configurations associated with cell #2 410 (e.g., in the FR1 cell/carrier). For CG, the UE 415 can transmit on any of the PUSCH resources belonging to the backup CG configuration associated with cell #2 410 (e.g., in the FR1 cell/carrier). While cell #1 405 is unavailable, the UE 415 and cell #2 410 may communicate using the PDSCH/PUSCHs associated with the backup SPS/CG configurations (450).

In an example implementation, the cell #1 405 and cell #2 410 can exchange information on the scheduling restrictions/unavailability (e.g., as a combination of cell-wide restrictions/unavailability and/or UE-specific scheduling restrictions/unavailability). Cell-wide restrictions could be e.g., related to TDD frame configuration, whereas UE-specific could be related to the UE's capabilities and the configured measurement gaps for that particular UE.

Regarding the time behaviour, scheduling restrictions/unavailability can occur in a predictable manner (e.g., periodically or with certain time pattern). Therefore, the scheduling restrictions/unavailability information may be signalled as a time pattern that applies for the next milliseconds/seconds/hours. Further, a dynamic indication may be used to cover events (e.g., beam refinement) for which their occurrence may not be known well in advance. This is of course subject to the delay of, for example, the Xn/F1 interfaces (e.g., the backhaul shown in FIG. 3).

Once cell #1 405 (e.g., FR2 cell) becomes again available, the UE 215 can stop transmitting/receiving data on the backup configurations, and resume transmission/reception on the primary configurations in cell #1 405 (e.g., the FR2 cell). Once cell #1 becomes available again, the UE 415 and cell #1 405 may resume normal operation (455).

In an example implementation, a transition or guard time can be configured such that the UE 415 does not immediately switch to transmit/receive on the primary configurations associated with cell #1 405. Instead, UE 415 could be schedulable from both cell #1 405 and cell #2 410. This guard time could be defined and signalled to the UE 415 in the form of absolute time (seconds/milliseconds or even shorter), number of symbols, slots, frames and/or the like. For example, the use of a transition or guard time could be useful in case there are some pending transmissions or HARQ retransmissions which should be correctly received via cell #2 410 (e.g., FR1 carrier) before switching to the primary configurations associated with cell #1 405.

In another example implementation, the guard time could be configured as a Timer after the ending of the measurement gap. Once the time expires, UE 415 can start to transmit/receive on the primary configurations associated with cell #1 405.

In an alternative implementation, SPS or CG PDSCH/PUSCHs that cannot be received/transmitted due to the scheduling unavailability can be translated on-the-fly to an equivalent PDSCH/PUSCH on the cell #2 410 (e.g., FR1 carrier) using certain specified rules. The rules can, for example, be specified (or configurable by gNB). Example rules can include start symbol of the equivalent cell #2 410 (e.g., FR1 carrier) PDSCH/PUSCH can consist on the first OFDM symbol in the cell #2 410 (e.g., FR1 carrier) that starts no earlier than the start symbol of the primary SPS/CG configuration and the time duration of the SPS/CG PDSCH/PUSCH corresponding to max(actual_duration_primary, min_duration_backup). For example, if a 2 symbol PDSCH/PUSCH transmission and 120 kHz SCS is used for the cell #1 405 (e.g., FR2 carrier) (e.g., resulting in a transmission duration of ˜17.8 μs), scheduling unavailability could be translated to a longer transmission duration in the second, secondary or backup cell 2 symbol and 30 kHz SCS resulting in a transmission duration of ˜71.4 μs. Similar logic can be applied for the PRB allocation in frequency, each PRB allocated in the cell #1 405 (e.g., FR2 carrier) with 120 kHz SCS (with total bandwidth of 12 subcarriers*120 kHz) could correspond to 4 PRBs in cell #2 410 (e.g., FR1 carrier) with 30 kHz SCS.

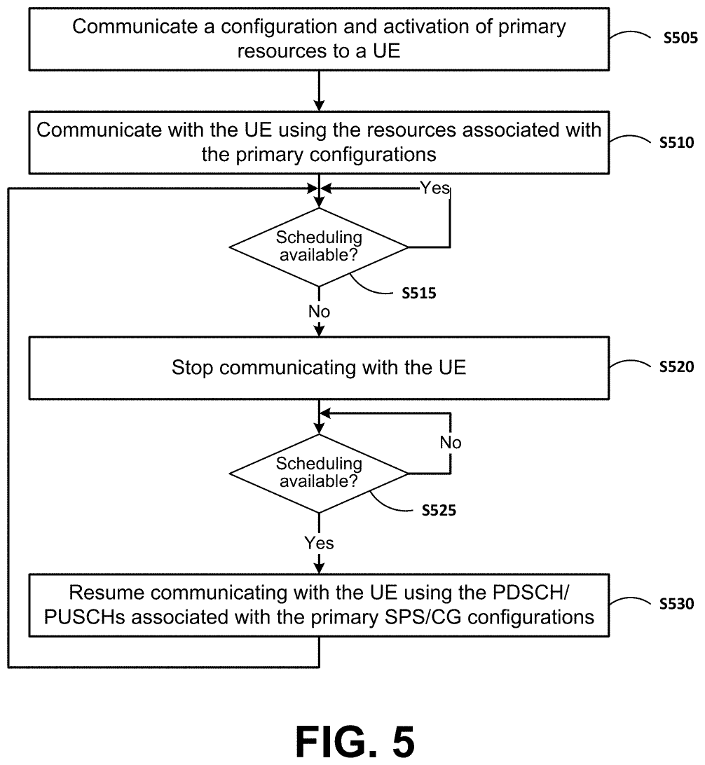

FIG. 5 is a block diagram of a method for wireless communication from the perspective of a primary cell according to at least one example embodiment. As shown in FIG. 5, in step S505 a configuration and activation of primary resources is communicated to a UE. The resources can include SPS/CG resources or dynamic signalling (e.g., where each PDSCH or PUSCH allocation is dynamically indicated with a DCI). For example, a message or signal can be communicated from the primary cell (e.g., cell #1 205, 405) to the UE (e.g., UE 215, 415). The message can include information (e.g., instructions) for configuration and activation of primary SPS/CG resources for communications between the primary cell and the UE. For example, the primary CG/SPS configurations can be configured in cell #1 205, 405 (e.g., the FR2 carrier/cell given FR2's large availability of spectrum). This can be accomplished by using a first RRC configuration step, followed by layer-1 activation via DCI for the case of DL SPS and Type-2 CG; whereas for Type-1 CG, RRC configuration is sufficient. PDSCHs/PUSCHs transmissions belonging to these primary SPS/CG configurations are illustrated in FIG. 3.

In step S510 begin communicating with the UE using the resources associated with the primary configurations. For example, after the activation of the resources, the UE and the primary cell can communicate via the configured resources. The resources can include SPS/CG resources or dynamic signalling (e.g., where each PDSCH or PUSCH allocation is dynamically indicated with a DCI). The primary cell (e.g., cell #1 205, 405), as a gNB, can communicate with the UE (e.g., UE 215, 415) and provide the UE with one or more SPS and/or CG configurations on one of the carriers/cells (e.g., as the primary CG/SPS configuration).

In step S515 the primary cell determines whether scheduling communications (e.g., to the UE) is available. If the primary cell (e.g., cell #1 205, 405) is unavailable for scheduling communications, processing continues to step S520. Otherwise, processing returns to step S515. For example, as shown in FIG. 3, there are times that the primary cell is unavailable for scheduling. Scheduling restrictions/unavailability can occur in a predictable manner (e.g., periodically or with certain time pattern). Therefore, the scheduling restrictions/unavailability information may be signalled to the secondary or backup cell (e.g., cell #2 210, 410) as a time pattern that applies for the next milliseconds/seconds/hours.

In step S520 communication with the UE is stopped. For example, the primary cell (e.g., cell #1 205, 405) can stop communicating to the UE (e.g., UE 215, 415) because scheduling a block(s) is not available for communications between the primary cell and the UE.

In step S525 the primary cell determines whether scheduling communications (e.g., to the UE) is available. If the primary cell is available for scheduling communications, processing continues to step S530. Otherwise, processing returns to step S525. For example, as shown in FIG. 3, there are times that the primary cell is unavailable for scheduling. Scheduling restrictions/unavailability can occur in a predictable manner (e.g., periodically or with certain time pattern). Therefore, the scheduling restrictions/unavailability information may be signalled as a time pattern that applies for the next milliseconds/seconds/hours.

In step S530 communication with the UE using the resources associated with the primary configurations is resumed. For example, after determining the primary cell is available for scheduling, the UE and the primary cell can communicate via the configured SPS/CG resources. The primary cell (e.g., cell #1 205, 405), as a gNB, can communicate with the UE (e.g., UE 215, 415 and provide the UE with one or more SPS and/or CG configurations on one of the carriers/cells (e.g., as the primary CG/SPS configuration).

In an example implementation, a transition or guard time can be configured such that the communications between the UE and the primary cell do not immediately switch to transmit/receive on the primary configurations associated with the primary cell. Instead, the UE could be schedulable from both the primary cell and a secondary or backup cell. This guard time could be defined and signalled to the UE in the form of absolute time (seconds/milliseconds or even shorter), number of symbols, slots, frames and/or the like. For example, the use of a transition or guard time could be useful in case there are some pending transmissions or HARQ retransmissions which should be correctly received via the secondary or backup cell (e.g., FR1 carrier) before switching to the primary configurations associated with the primary cell. In another example implementation, the guard time could be configured as a timer after the ending of the measurement gap. Once the time expires, the UE can start to transmit/receive on the primary configurations associated with the primary cell.

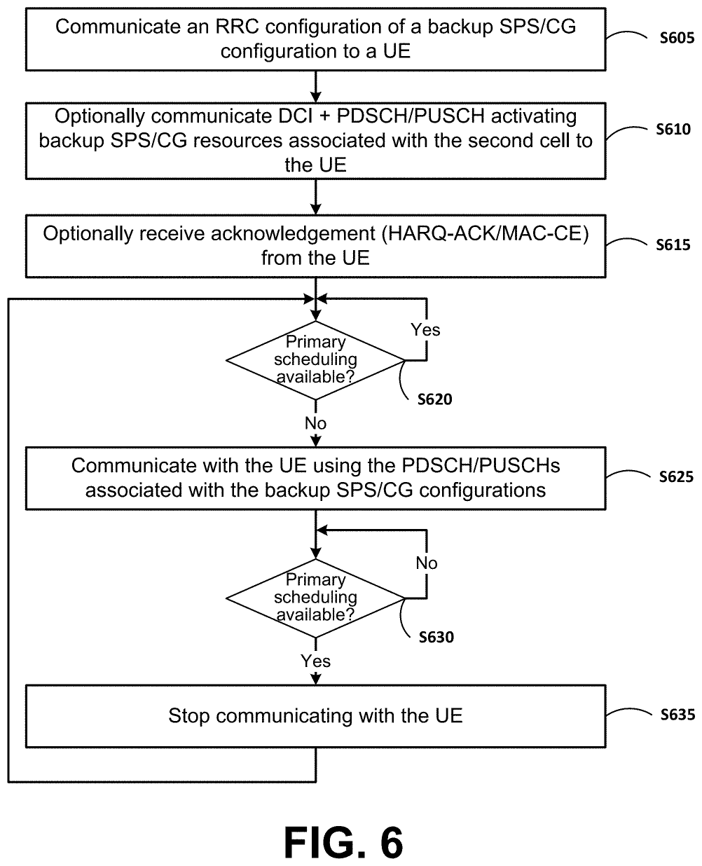

FIG. 6 is a block diagram of a method for wireless communication from the perspective of a secondary cell according to at least one example embodiment. As shown in FIG. 6, in step S605 an RRC configuration of a backup SPS/CG configuration is communicated to a UE. For example, a backup or secondary cell (e.g., cell #2 210, 410) can communicate messages (e.g., a configuration message or signal) to a UE (e.g., UE 215, 415). In an example implementation, a primary cell can have one or more backup or secondary cells. The messages can include an RRC configuration of a backup SPS/CG configuration. The signalling of a backup SPS/CG configuration can be based on existing RRC configuration procedure (e.g., as described in TS 38.331). For example, the UE can be provided with one or more of SPS-Config and/or ConfiguredGrantConfig information elements (IE), including a 1-bit ‘flag’ that indicates to the UE that those SPS/CG configurations shall be regarded as a backup configuration.

In step S610 DCI+PDSCH/PUSCH activating backup SPS/CG resources associated with the second cell is optionally communicated to the UE. In step S615 an acknowledgement (e.g., HARQ-ACK/MAC-CE) is optionally received from the UE. For example, for SPS and Type-2 CG, the messages can include DCI and PDSCH/PUSCH activating the backup SPS/CG resources communicated from the secondary or backup cell to the UE and an acknowledgement (e.g., HARQ-ACK/MAC-CE) can be communicated from the UE to the second, secondary or backup cell. The backup SPS/CG resources may not be used (for communications with the UE) while a primary cell is available.

In an example implementation, individual backup SPS/CG configuration(s) can be linked to specific cell(s), e.g., via providing the cell id as part of the RRC configuration of the SPS/CG. The UE can start receiving/transmitting on the backup SPS/CG configurations if there is a scheduling unavailability on those specific cell(s). For example, in case of CA/DC with one (1) second or secondary cell (e.g., FR1 carrier) and two (2) primary cells (e.g., FR2 carriers), there can be one backup SPS/CG configuration that is used upon scheduling unavailability of the primary cell (e.g., FR2 cell), and another backup SPS/CG that is used upon scheduling unavailability of the secondary cell (e.g., FR2 cell).

In an example implementation, there can be an explicit link between the primary CG/SPS configurations associated with the primary cell and the backup CG/SPS configurations associated with secondary cell. This technique could be done by defining a new global index number. This technique is described in more detail above.

In step S620 the backup (or secondary) cell determines whether scheduling communications (e.g., to the UE) is available at the primary cell. If scheduling communications is not available at the primary cell, processing continues to step S625. Otherwise, processing returns to step S620. For example, as shown in FIG. 3, there are times that the primary cell is unavailable for scheduling. In an example implementation, the primary cell and the secondary cell can exchange information on the scheduling restrictions/unavailability (e.g., as a combination of cell-wide restrictions/unavailability and UE-specific scheduling restrictions/unavailability). Cell-wide restrictions could be related to TDD frame configuration, whereas UE-specific could be related to the UE's capabilities and the configured measurement gaps for that particular UE. Scheduling restrictions/unavailability can occur in a predictable manner (e.g., periodically or with certain time pattern). Therefore, the scheduling restrictions/unavailability information may be signalled as a time pattern that applies for the next milliseconds/seconds/hours. In another example implementation, the usage of backup SPS/CG configurations at the secondary or backup cell can be dynamically triggered by the primary cell as well for example when the primary cell cannot provide sufficient QoS support to the UE. Such triggering signal can be delivered over backhaul interface for example Xn interface or F1 interface or other type of backhaul interface.

In step S625 begin communicating with the UE using the PDSCH/PUSCHs associated with the backup SPS/CG configurations. In case there is scheduling unavailability/restriction on the primary cell (e.g., FR2 cell) (see FIG. 3), the UE can for SPS, start receiving PDSCH belonging to the backup SPS configurations associated with the secondary or backup cell (e.g., in the FR1 cell/carrier). For CG, the UE can transmit on any of the PUSCH resources belonging to the backup CG configuration associated with the secondary or backup cell (e.g., in the FR1 cell/carrier). While the primary cell is unavailable, the UE and the backup cell may communicate using the PDSCH/PUSCHs associated with the secondary or backup SPS/CG configurations.

In step S630 the secondary or backup cell determines whether scheduling communications (e.g., to the UE) is available at the primary cell. If scheduling communications is available at the primary cell, processing continues to step S635. Otherwise, processing returns to step S630. For example, as shown in FIG. 3, there are times that the primary cell is unavailable for scheduling. In an example implementation, the primary cell and the secondary or backup cell can exchange information on the scheduling restrictions/unavailability (e.g., as a combination of cell-wide restrictions/unavailability and UE-specific scheduling restrictions/unavailability). Cell-wide restrictions could be related to TDD frame configuration, whereas UE-specific could be related to the UE's capabilities and the configured measurement gaps for that particular UE. Scheduling restrictions/unavailability can occur in a predictable manner (e.g., periodically or with certain time pattern). Therefore, the scheduling restrictions/unavailability information may be signalled as a time pattern that applies for the next milliseconds/seconds/hours.

In step S635 communication with the UE is stopped. For example, communications from the secondary or backup cell to the UE can be stopped because the primary cell is available for communications with the UE. In an example implementation, a transition or guard time can be configured such that the communications between the UE and the primary cell do not immediately switch to transmit/receive on the primary configurations associated with the primary cell. Instead, the UE could be schedulable from both the primary cell and the secondary or backup cell. This guard time could be defined and signalled to the UE in the form of absolute time (seconds/milliseconds or even shorter), number of symbols, slots, and/or the like. For example, the use of a transition or guard time could be useful in case there are some pending transmissions or HARQ retransmissions which should be correctly received via the secondary or backup cell (e.g., FR1 carrier) before switching to the primary configurations associated with the primary cell. In another example implementation, the guard time could be configured as a timer after the ending of the measurement gap. Once the time expires, the UE can start to transmit/receive on the primary configurations associated with the primary cell.

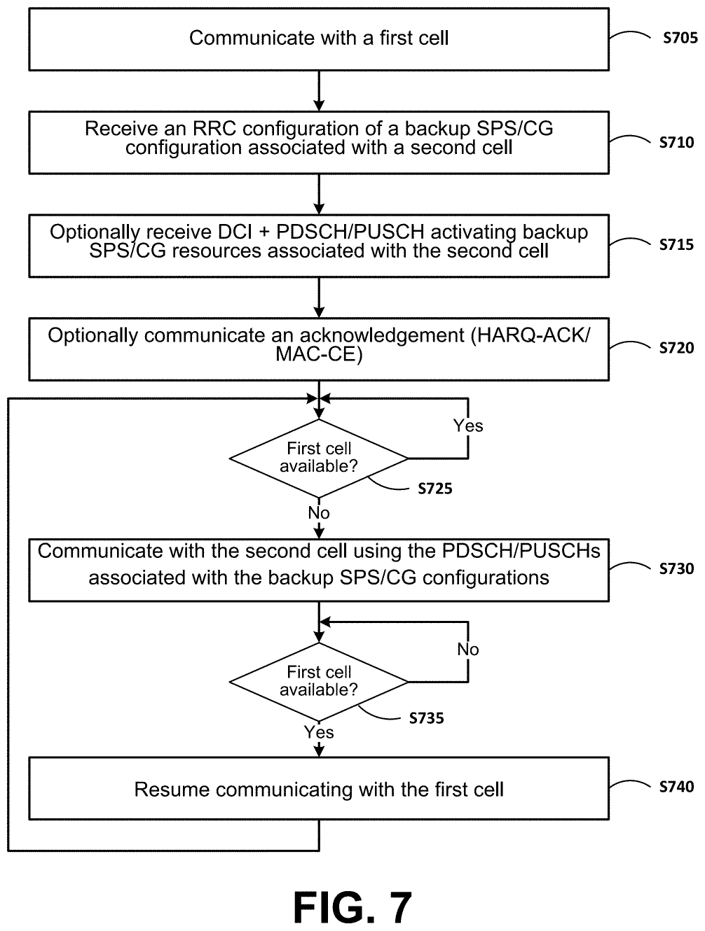

FIG. 7 is a block diagram of a method for wireless communication from the perspective of a user equipment (UE) according to at least one example embodiment. As shown in FIG. 7, in step S705 communicate with a first cell. The communication can use a primary resource configuration. The primary resources can include SPS/CG resources or dynamic signalling (e.g., where each PDSCH or PUSCH allocation is dynamically indicated with a DCI). For example, a message or signal can be communicated from the first or primary cell (e.g., cell #1 205, 405) to the UE (e.g., UE 215, 415). The message can include (e.g., include instructions) for configuration and activation of primary SPS/CG resources for communications between the primary cell and the UE. For example, the primary CG/SPS configurations can be configured in cell #1 205, 405 (e.g., the FR2 carrier/cell given FR2s large availability of spectrum). This can be accomplished by using a first RRC configuration step, followed by layer-1 activation via DCI for the case of DL SPS and Type-2 CG; whereas for Type-1 CG, RRC configuration is sufficient. PDSCHs/PUSCHs transmissions belonging to these primary SPS/CG configurations are illustrated in FIG. 3.

In step S710 an RRC configuration of a backup SPS/CG configuration associated with a second cell is received. For example, a backup or secondary cell (e.g., cell #2 210, 410) can communicate messages (e.g., a configuration message or signal) to a UE (e.g., UE 215, 415). The messages can include an RRC configuration of a backup SPS/CG configuration. For example, the signalling of a backup SPS/CG configuration can be based on existing RRC configuration procedure (e.g., as in TS 38.331). For example, the procedure can include providing the UE with one or more of SPS-Config and/or ConfiguredGrantConfig information elements (IE), including a 1-bit ‘flag’ that indicates to the UE that those SPS/CG configurations shall be regarded as a backup configuration.

In step S715 a DCI+PDSCH/PUSCH activating backup SPS/CG resources associated with the second cell is optionally received. In step S720 an acknowledgement (e.g., HARQ-ACK/MAC-CE) is optionally communicated. For example, for SPS and Type 2 CG, the messages can include DCI and PDSCH/PUSCH activating the backup SPS/CG resources communicated from the secondary or backup cell to the UE and an acknowledgement (e.g., HARQ-ACK/MAC-CE) can be communicated from the UE to the secondary or backup cell. The backup SPS/CG resources may not be used (for communications with the UE) while a primary cell is available.

In an example implementation, individual backup SPS/CG configuration can be linked to specific cell(s), e.g., via providing the cell id as part of the RRC configuration of the SPS/CG. The UE can start receiving/transmitting on the backup SPS/CG configurations if there is a scheduling unavailability on those specific cell(s). For example, in case of CA/DC with one (1) secondary or backup cell (e.g., FR1 carrier) and two (2) primary cells (e.g., FR2 carriers), there can be one backup SPS/CG configuration that is used upon scheduling unavailability of the primary cell (e.g., FR2 cell), and another backup SPS/CG that is used upon scheduling unavailability of the second primary cell (e.g., FR2 cell).

In step S725 the UE determines whether scheduling communications (e.g., to the UE) is available at the first (e.g., primary) cell. If scheduling communications is not available at the first (e.g., primary) cell processing continues to step S730. Otherwise, processing returns to step S725. For example, as shown in FIG. 3, there are times that the primary cell is unavailable for scheduling. In an example implementation, the primary cell and the secondary or backup cell can exchange information on the scheduling restrictions/unavailability (e.g., as a combination of cell-wide restrictions/unavailability and UE-specific scheduling restrictions/unavailability). Cell-wide restrictions could be related to TDD frame configuration, whereas UE-specific could be related to the UE's capabilities and the configured measurement gaps for that particular UE. Scheduling restrictions/unavailability can occur in a predictable manner (e.g., periodically or with certain time pattern). Therefore, the scheduling restrictions/unavailability information may be signalled as a time pattern that applies for the next milliseconds/seconds/hours.

In step S730 communication with the second cell using the PDSCH/PUSCHs associated with the backup SPS/CG configurations is begun. In case there is scheduling unavailability/restriction on the primary cell (e.g., FR2 call) (see FIG. 3), the UE can for SPS, start receiving PDSCH belonging to the backup SPS configurations associated with the secondary or backup cell (e.g., in the FR1 cell/carrier). For CG, the UE can transmit on any of the PUSCH resources belonging to the backup CG configuration associated with the secondary or backup cell (e.g., in the FR1 cell/carrier). While the primary cell is unavailable, the UE and the secondary or backup cell may communicate using the PDSCH/PUSCHs associated with the backup SPS/CG configurations.

In step S735 the UE determines whether scheduling communications (e.g., to the UE) is available at the first (e.g., primary) cell. If scheduling communications is available at the first (e.g., primary) cell processing continues to step S740. Otherwise, processing returns to step S735. For example, as shown in FIG. 3, there are times that the primary cell is unavailable for scheduling. In an example implementation, the primary cell and the secondary or backup cell can exchange information on the scheduling restrictions/unavailability (e.g., as a combination of cell-wide restrictions/unavailability and UE-specific scheduling restrictions/unavailability). Cell-wide restrictions could be related to TDD frame configuration, whereas UE-specific could be related to the UE's capabilities and the configured measurement gaps for that particular UE. Scheduling restrictions/unavailability can occur in a predictable manner (e.g., periodically or with certain time pattern). Therefore, the scheduling restrictions/unavailability information may be signalled as a time pattern that applies for the next milliseconds/seconds/hours.

In step S740 communication with the first cell is resumed. The communication can be resumed using the PDSCH/PUSCHs associated with the primary SPS/CG configurations. For example, after determining the primary cell is available for scheduling, the UE and the primary cell can communicate via the configured SPS/CG resources. The primary cell (e.g., cell #1 205, 405), as a gNB, can communicate with the UE (e.g., UE 215, 415 and provide the UE with one or more SPS and/or CG configurations on one of the carriers/cells (e.g., as the primary CG/SPS configuration).

In an example implementation, a transition or guard time can be configured such that the communications between the UE and the primary cell do not immediately switch to transmit/receive on the primary configurations associated with the primary cell. Instead, the UE could be schedulable from both the primary cell and a secondary or backup cell. This guard time could be defined and signalled to the UE in the form of absolute time (seconds/milliseconds or even shorter), number of symbols, slots, and/or the like. For example, the use of a transition or guard time could be useful in case there are some pending transmissions or HARQ retransmissions which should be correctly received via the secondary or backup cell (e.g., FR1 carrier) before switching to the primary configurations associated with the primary cell. In another example implementation, the guard time could be configured as a timer after the ending of the measurement gap. Once the time expires, the UE can start to transmit/receive on the primary configurations associated with the primary cell.

### SOME EXAMPLE ADVANTAGES

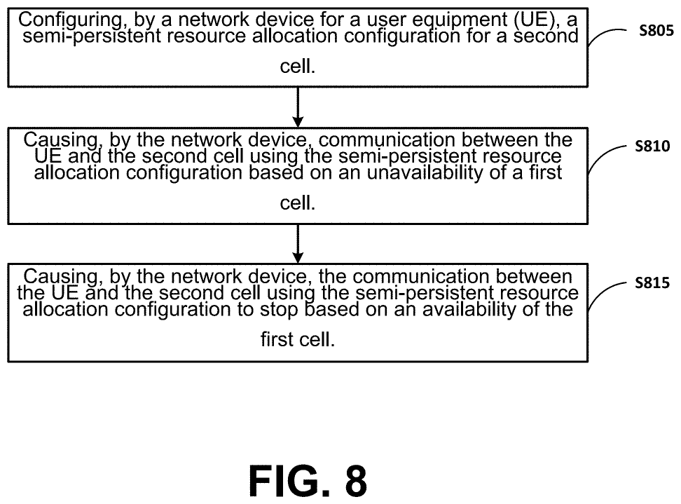

Example 1. FIG. 8 is a flowchart illustrating operation of network device. Operation S805 includes configuring, by a network device for a user equipment (UE), a semi-persistent resource allocation configuration for a second cell. Operation S810 includes causing, by the network device, communication between the UE and the second cell using the semi-persistent resource allocation configuration based on an unavailability of a first cell. Operation S815 includes causing, by the network device, the communication between the UE and the second cell using the semi-persistent resource allocation configuration to stop based on an availability of the first cell.

Example 2. The method of Example 1, wherein the semi-persistent resource allocation configuration can include at least one of a semi-persistent scheduling (SPS) configuration and a configured grant (CG) configuration as a CG/SPS configuration.

Example 3. The method of Example 1 or Example 2, can further include configuring, by the network device for the UE, at least one of a SPS configuration and a CG configuration as a CG/SPS configuration for at least one additional cell, causing, by the network device, communication between the UE and the at least one additional cell using the CG/SPS configuration for the at least one additional cell based on the unavailability of the first cell and the second cell, and causing, by the network device, communication between the UE and the at least one additional cell using the CG/SPS configuration for the at least one additional cell to stop based on the availability of the first cell.

Example 4. The method of any of Example 1 to Example 3, can further include communicating, by the network device to the UE, a CG/SPS configuration for the second cell with a downlink control information (DCI) and receiving, by the network device from the UE, a hybrid automatic repeat request (HARQ)-acknowledgement (ACK) feedback with the DCI.

Example 5. The method of any of Example 1 to Example 4, can further include communicating, by the network device to the UE, a CG/SPS configuration for the second cell with a downlink control information (DCI) and receiving, by the network device from the UE, a Configured Grant Confirmation medium access control (MAC) control element (CE) with the DCI.

Example 6. The method of any of Example 1 to Example 5, wherein after the first cell is available for scheduling, delaying the stopping of the communication between the UE and the second cell based on one of a fixed period of time, after a timer has expired, a number of symbols, a number of slots, or a completion of a HARQ retransmission.

Example 7. The method of any of Example 1 to Example 6, wherein a CG/SPS configuration for the second cell can be linked to at least one of the first cell and additional cells based on a cell identification included in a radio resource control (RRC) configuration of the SPS/CG configuration and the CG/SPS configuration for the second cell can be used if resources from a CG/SPS configuration for at least one of the first cell and the additional cells are not available due to a scheduling unavailability.

Example 8. The method of any of Example 1 to Example 7, can further include communicating, by the network device to the UE, at least one of a SPS configuration and a CG configuration as a CG/SPS configuration for the first cell wherein a CG/SPS configuration for the second cell is linked to the CG/SPS configuration for the first cell and the CG/SPS configuration for the second cell is used if at least one resource from the CG/SPS of the first configuration is not available due to a scheduling unavailability.

Example 9. The method of any of Example 1 to Example 8, can further include exchanging, between the first cell and the second cell, information on scheduling restrictions/unavailability based on cell-wide restrictions/unavailability, UE-specific scheduling restrictions/unavailability, or a combination of cell-wide restrictions/unavailability and UE-specific scheduling restrictions/unavailability.

Example 10. The method of any of Example 1 to Example 9, wherein the network device is a first network device and the second cell is associated with a second network device, the method can further include communicating, by the first network device to the second network device, a portion of the CG/SPS configuration for the second cell using signalling over at least one of a F1 interface and a Xn interface.

Example 11. The method of any of Example 1 to Example 10, can further include determining the first cell is unavailable based on at least one of a TDD configuration, UE intra-cell/inter-cell measurements, beam alignment, mobility measurements on neighboring cells, and handover interruption time.

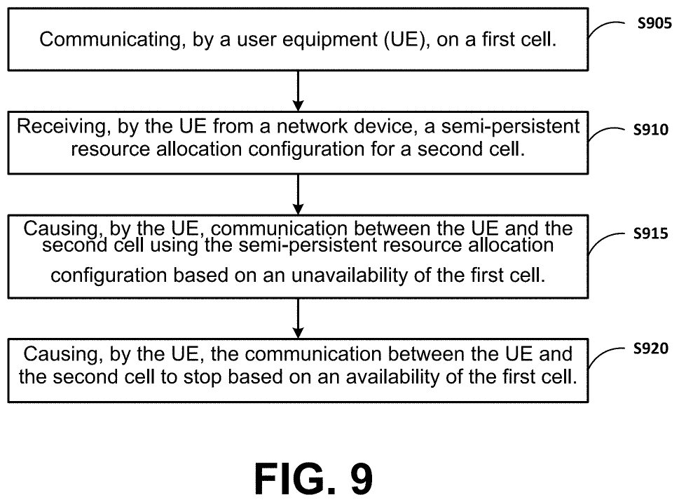

Example 12. FIG. 9 is a flowchart illustrating operation of a user equipment. Operation S905 includes communicating, by a user equipment (UE), on a first cell. Operation S910 includes receiving, by the UE from a network device, a semi-persistent resource allocation configuration for a second cell. Operation S915 includes causing, by the UE, communication between the UE and the second cell using the semi-persistent resource allocation configuration based on an unavailability of the first cell. Operation S920 includes causing, by the UE, the communication between the UE and the second cell to stop based on an availability of the first cell.

Example 13. The method of Example 12, wherein the semi-persistent resource allocation configuration can include at least one of a semi-persistent scheduling (SPS) configuration and a configured grant (CG) configuration as a CG/SPS configuration.

Example 14. The method of Example 12 or Example 13, can further include receiving, by the UE from the network device, at least one of a SPS configuration and a CG configuration as a CG/SPS configuration for at least one additional cell, causing, by the UE, communication between the UE and the at least one additional cell using the CG/SPS configuration for the at least one additional cell, and causing, by the UE, communication between the UE and the at least one additional cell using the CG/SPS configuration for the at least one additional cell to stop.

Example 15. The method of any of Example 12 to Example 14, wherein after the first cell is available for scheduling, delaying the stopping of the communication between the UE and the second cell based on one of a fixed period of time, after a timer has expired, a number of symbols, a number of slots, or a completion of a HARQ retransmission.

Example 16. The method of any of Example 12 to Example 15, wherein a CG/SPS configuration for the second cell can be linked to at least one of the first cell and additional cells based on a cell identification included in a radio resource control (RRC) configuration of the SPS/CG configuration and the CG/SPS configuration for the second cell can be used if resources from a CG/SPS configuration for at least one of the first cell and the additional cells are not available due to a scheduling unavailability.

Example 17. The method of any of Example 12 to Example 16, can further include receiving, by the UE from the network device, at least one of a SPS configuration and a CG configuration as a CG/SPS configuration for the first cell wherein a CG/SPS configuration for the second cell is linked to the CG/SPS configuration for the first cell and the CG/SPS configuration for the second cell is used if at least one resource from the CG/SPS of the first configuration is not available due to a scheduling unavailability.

Example 18. The method of any of Example 12 to Example 17, can further include determining the first cell is unavailable based on at least one of a TDD configuration, UE intra-cell/inter-cell measurements, beam alignment, mobility measurements on neighboring cells, and handover interruption time.

Example 19. A non-transitory computer-readable storage medium comprising instructions stored thereon that, when executed by at least one processor, are configured to cause a computing system to perform the method of any of Examples 1-18.

Example 20. An apparatus comprising means for performing the method of any of Examples 1-18.

Example 21. An apparatus comprising: at least one processor; and at least one memory including computer program code; the at least one memory and the computer program code configured to, with the at least one processor, cause the apparatus at least to perform the method of any of Examples 1-18.

The computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

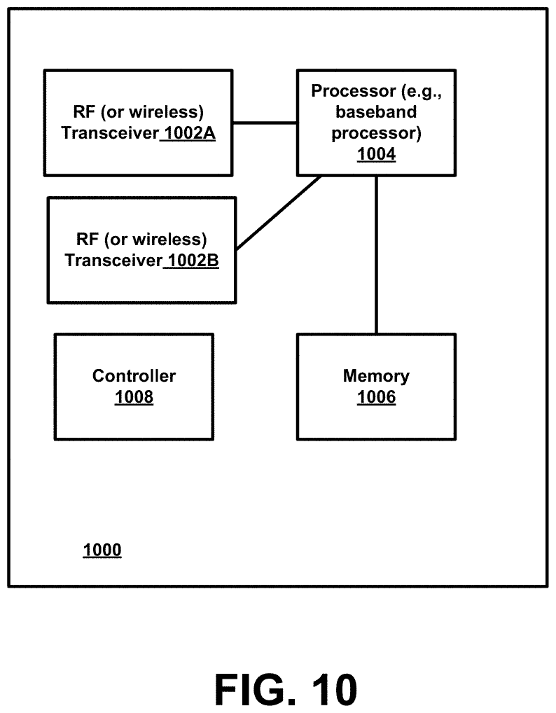

FIG. 10 is a block diagram of a wireless station 1000 or wireless node or network node 1000 according to an example embodiment. The wireless node or wireless station or network node 1000 may include, e.g., one or more of an AP, BS, gNB, RAN node, relay node, UE or user device, network node, network entity, DU, CU-CP, CU-UP, . . . or other node) according to an example embodiment.

The wireless station 1000 may include, for example, one or more (e.g., two as shown in FIG. 10) radio frequency (RF) or wireless transceivers 1002A, 1002B, where each wireless transceiver includes a transmitter to transmit signals and a receiver to receive signals. The wireless station also includes a processor or control unit/entity (controller) 1004 to execute instructions or software and control transmission and receptions of signals, and a memory 1006 to store data and/or instructions.

Processor 1004 may also make decisions or determinations, generate frames, packets or messages for transmission, decode received frames or messages for further processing, and other tasks or functions described herein. Processor 1004, which may be a baseband processor, for example, may generate messages, packets, frames or other signals for transmission via wireless transceiver 1002 (1002A or 1002B). Processor 1004 may control transmission of signals or messages over a wireless network, and may control the reception of signals or messages, etc., via a wireless network (e.g., after being down-converted by wireless transceiver 1002, for example). Processor 1004 may be programmable and capable of executing software or other instructions stored in memory or on other computer media to perform the various tasks and functions described above, such as one or more of the tasks or methods described above. Processor 1004 may be (or may include), for example, hardware, programmable logic, a programmable processor that executes software or firmware, and/or any combination of these. Using other terminology, processor 1004 and transceiver 1002 together may be considered as a wireless transmitter/receiver system, for example.

In addition, referring to FIG. 10, a controller (or processor) 1008 may execute software and instructions, and may provide overall control for the station 1000, and may provide control for other systems not shown in FIG. 10, such as controlling input/output devices (e.g., display, keypad), and/or may execute software for one or more applications that may be provided on wireless station 1000, such as, for example, an email program, audio/video applications, a word processor, a Voice over IP application, or other application or software.

In addition, a storage medium may be provided that includes stored instructions, which when executed by a controller or processor may result in the processor 1004, or other controller or processor, performing one or more of the functions or tasks described above.

According to another example embodiment, RF or wireless transceiver(s) 1002A/1002B may receive signals or data and/or transmit or send signals or data. Processor 1004 (and possibly transceivers 1002A/1002B) may control the RF or wireless transceiver 1002A or 1002B to receive, send, broadcast or transmit signals or data.

The example embodiments are not, however, restricted to the system that is given as an example, but a person skilled in the art may apply the solution to other communication systems. Another example of a suitable communications system is the 5G system. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Example embodiments of the various techniques described herein may be implemented in digital electronic circuitry, or in computer hardware, firmware, software, or in combinations of them. Example embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, example embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Example embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
configuring, by a network device for a user equipment (UE), a semi-persistent resource allocation configuration for a second cell;
causing, by the network device, communication between the UE and the second cell using the semi-persistent resource allocation configuration based on an unavailability of a first cell; and
causing, by the network device, the communication between the UE and the second cell using the semi-persistent resource allocation configuration to stop based on an availability of the first cell.

2. The method of claim 1, wherein the semi-persistent resource allocation configuration includes at least one of a semi-persistent scheduling (SPS) configuration and a configured grant (CG) configuration as a CG/SPS configuration.

3. The method of claim 1, further comprising:
configuring, by the network device for the UE, at least one of a SPS configuration and a CG configuration as a CG/SPS configuration for at least one additional cell;
causing, by the network device, communication between the UE and the at least one additional cell using the CG/SPS configuration for the at least one additional cell based on the unavailability of the first cell and the second cell; and
causing, by the network device, communication between the UE and the at least one additional cell using the CG/SPS configuration for the at least one additional cell to stop based on the availability of the first cell.

4. The method of claim 1, further comprising:
communicating, by the network device to the UE, a CG/SPS configuration for the second cell with a downlink control information (DCI); and
receiving, by the network device from the UE, a hybrid automatic repeat request (HARQ)-acknowledgement (ACK) feedback with the DCI.

5. The method of claim 1, further comprising:
communicating, by the network device to the UE, a CG/SPS configuration for the second cell with a downlink control information (DCI); and
receiving, by the network device from the UE, a Configured Grant Confirmation medium access control (MAC) control element (CE) with the DCI.

6. The method of claim 1, wherein after the first cell is available for scheduling, delaying the stopping of the communication between the UE and the second cell based on one of a fixed period of time, after a timer has expired, a number of symbols, a number of slots, or a completion of a HARQ retransmission.

7. The method of claim 1, wherein
a CG/SPS configuration for the second cell is linked to at least one of the first cell and additional cells based on a cell identification included in a radio resource control (RRC) configuration of the SPS/CG configuration, and
the CG/SPS configuration for the second cell is used if resources from a CG/SPS configuration for at least one of the first cell and the additional cells are not available due to a scheduling unavailability.

8. The method of claim 1, further comprising:
communicating, by the network device to the UE, at least one of a SPS configuration and a CG configuration as a CG/SPS configuration for the first cell wherein a CG/SPS configuration for the second cell is linked to the CG/SPS configuration for the first cell and the CG/SPS configuration for the second cell is used if at least one resource from the CG/SPS of the first configuration is not available due to a scheduling unavailability.

9. The method of claim 1, further comprising:
exchanging, between the first cell and the second cell, information on scheduling restrictions/unavailability based on cell-wide restrictions/unavailability, UE-specific scheduling restrictions/unavailability, or a combination of cell-wide restrictions/unavailability and UE-specific scheduling restrictions/unavailability.

10. The method of claim 1, wherein the network device is a first network device and the second cell is associated with a second network device, the method further comprising:
communicating, by the first network device to the second network device, a portion of a CG/SPS configuration for the second cell using signalling over at least one of a F1 interface and a Xn interface.

11. The method of claim 1, further comprising determining the first cell is unavailable based on at least one of a TDD configuration, UE intra-cell/inter-cell measurements, beam alignment, mobility measurements on neighboring cells, and handover interruption time.

12. A method comprising:
communicating, by a user equipment (UE), on a first cell;
receiving, by the UE from a network device, a semi-persistent resource allocation configuration for a second cell;
causing, by the UE, communication between the UE and the second cell using the semi-persistent resource allocation configuration based on an unavailability of the first cell; and
causing, by the UE, the communication between the UE and the second cell to stop based on an availability of the first cell.

13. The method of claim 12, wherein the semi-persistent resource allocation configuration includes at least one of a semi-persistent scheduling (SPS) configuration and a configured grant (CG) configuration as a CG/SPS configuration.

14. The method of claim 12, further comprising:
receiving, by the UE from the network device, at least one of a SPS configuration and a CG configuration as a CG/SPS configuration for at least one additional cell;
causing, by the UE, communication between the UE and the at least one additional cell using the CG/SPS configuration for the at least one additional cell; and
causing, by the UE, communication between the UE and the at least one additional cell using the CG/SPS configuration for the at least one additional cell to stop.

15. The method of claim 12, wherein after the first cell is available for scheduling, delaying the stopping of the communication between the UE and the second cell based on one of a fixed period of time, after a timer has expired, a number of symbols, a number of slots, or a completion of a HARQ retransmission.

16. The method of claim 12, wherein
a CG/SPS configuration for the second cell is linked to at least one of the first cell and additional cells based on a cell identification included in a radio resource control (RRC) configuration of the SPS/CG configuration, and
the CG/SPS configuration for the second cell is used if resources from a CG/SPS configuration for at least one of the first cell and the additional cells are not available due to a scheduling unavailability.

17. The method of claim 12, further comprising:
receiving, by the UE from the network device, at least one of a SPS configuration and a CG configuration as a CG/SPS configuration for the first cell wherein a CG/SPS configuration for the second cell is linked to the CG/SPS configuration for the first cell and the CG/SPS configuration for the second cell is used if at least one resource from the CG/SPS of the first configuration is not available due to a scheduling unavailability.

18. The method of claim 12, further comprising determining the first cell is unavailable based on at least one of a TDD configuration, UE intra-cell/inter-cell measurements, beam alignment, mobility measurements on neighboring cells, and handover interruption time.

19. A non-transitory computer-readable storage medium comprising instructions stored thereon that, when executed by at least one processor, are configured to cause a computing system to perform steps comprising:
configuring, by a network device for a user equipment (UE), at least one semi-persistent resource allocation configuration for a second cell;
causing, by the network device, communication between the UE and the second cell using the semi-persistent resource allocation configuration based on an unavailability of a first cell; and
causing, by the network device, the communication between the UE and the second cell using the semi-persistent resource allocation configuration to stop based on an availability of the first cell.

20. The storage medium of claim 19, wherein the steps further comprise:
configuring, by the network device for the UE, at least one of a SPS configuration and a CG configuration as a CG/SPS configuration for at least one additional cell;
causing, by the network device, communication between the UE and the at least one additional cell using the CG/SPS configuration for the at least one additional cell based on the unavailability of the first cell and the second cell; and
causing, by the network device, communication between the UE and the at least one additional cell using the CG/SPS configuration for the at least one additional cell to stop based on the availability of the first cell.
